(19) United States
(12) Patent Application Publication
(10) Pub. No.: US 2004/0075696 A1
(43) Pub. Date: Apr. 22, 2004

(54) System and method for automatic mnemonic assignment

(75) Inventors: Zeke Koch, Seattle, WA (US); Eduardo Luis Escardo-Raffo, Seattle, WA (US); Felix GTI Andrew, Seattle, WA (US)

Correspondence Address: MERCHANT & GOULD, P.O. BOX 2903, MINNEAPOLIS, MN, 55402-0903, US

(73) Assignee: Microsoft Corporation, Redmond, WA

(21) Appl. No.: 10/400,268

(22) Filed: Mar. 26, 2003

Related U.S. Application Data
(60) Provisional application No. 60/420,427, filed on Oct. 21, 2002.

(51) Int. Cl. G09G 5/00

(52) U.S. Cl. 345/827

(57) ABSTRACT

The invention provides an automated system and method for assigning mnemonics to menu items. A computer-implemented method is provided for configuring a user-interface that includes menu items. The computer-implemented method automatically assigns mnemonics to menu items. Each mnemonic is associated with a keyboard input and enables a user to select the corresponding menu item using a keyboard. The menu item is activated in response to the keyboard input.

### CLAIM OF PRIORITY

This application claims the benefit of U.S. Provisional Application No. 60/420,427, filed on Oct. 21, 2002.

### BACKGROUND OF THE INVENTION

Software developers often design applications that enable users to issue commands in a user-interface by selecting items on menus. These applications are commonly called menu-driven applications and are typically more user-friendly than command-driven applications. A menu-driven application works best with a pointing device, such as a mouse. However, in many situations, using a point device may not be the most practical or efficient way to select menu items in a menu-driven application. For example, many mobile computing devices, such as laptop computers, personal data assistants and multi-use wireless phones, do not have a mouse that is readily available for selecting menu items. Many experienced users also find that commonly used commands can be entered faster and more efficiently using a keyboard than using a pointing device.

In order to enable users to quickly and conveniently select menu items, many menu-driven applications often provide mnemonics, which allow the users to access menu items using a keyboard. Mnemonics allow fast access to menu items and additional functionalities, particularly in computing device with limited input capabilities. However, testing mnemonics is often tedious and labor-intensive, and typically generates a huge number of errors. An efficiently method for implementing mnemonics in a user-interface continues to elude those skilled in the art.

### SUMMARY OF THE INVENTION

Briefly stated, the present invention provides an automated system and method for assigning mnemonics to menu items. In one aspect, a computer-implemented method is provided for configuring a user-interface that includes menu items. The computer-implemented method automatically assigns mnemonics to menu items. Each mnemonic is associated with a keyboard input and enables a user to select the corresponding menu item using a keyboard. The menu item is activated in response to the keyboard input.

In another aspect, the invention is directed to assigning mnemonics to menu items that are dynamically generated. An application is configured to dynamically generate menu items. Mnemonics are automatically assigned to the menu items after they have been generated.

In yet another aspect, the invention is directed to a computer-executable medium encoded with computer-executable components that include an application and a mnemonic generator. The application is configured with a user-interface that includes menu items. The application may be configured to dynamically generate the menu items. The mnemonic generator is configured to assign mnemonics to the menu items. Each mnemonic is associated with a keyboard input. The mnemonic generator is also configured to activating a particular menu item in response to a keyboard input associated with the mnemonic that is assigned to that menu item.

### BRIEF DESCRIPTION OF THE DRAWINGS

FIG. 1 illustrates an exemplary computing device that may be used in one exemplary embodiment of the present invention.

FIG. 2 is a schematic diagram of a mnemonics generating system.

FIG. 3 is an exemplary process for automatically assigning mnemonics to menu items.

FIG. 4 an exemplary process for automatically assigning mnemonics to menu items with an application mnemonic preference.

FIG. 5 an exemplary process for automatically assigning mnemonics to menu items with a global mnemonic preference.

FIG. 6 an exemplary process for automatically assigning mnemonics to menu items without a mnemonic preference.

### DETAILED DESCRIPTION OF THE PREFERRED EMBODIMENT

Mnemonics enable a user to select menu items using a keyboard. Mnemonics may be characters, numbers, or other data that can be input using a keyboard. For example, by pressing different character keys in conjunction with a modifier key, a user can select menu items such as a pull down menu, a sub-menu, an action, etc.

The inventors of the present invention have determined that using a consistent and efficient process for assigning mnemonics to menu items will significantly simplify the creation and testing of computer-executable components. The inventors have also appreciated that computer-executable components with mnemonics that are assigned by such a process will be more compatible with each other. Thus, the present invention focuses on a system and method for automatically assigning mnemonics to menu items. The manner in which mnemonics are assigned by the present invention is very different from conventional methods. Typically, mnemonics are assigned to a user-interface based on subjective decisions made by a developer. Significant time and effort are demanded from the developer for assigning mnemonics in this manner. Because the developer has to manually account for many mnemonics assignments, errors generated as a result assigning the same mnemonic to more than one menu item are common. Also, manually assigning mnemonics is only feasible for menu items that are hard coded into a user-interface and will not work effectively for menu items that are generated dynamically.

In contrast, the present invention provides a more consistent and efficient approach. The present invention provides an automated system and method for assigning mnemonics in a user-interface. The automated system and method systematically assign mnemonics to minimize errors and to attain consistency among applications. The present invention also enables mnemonics to be assigned to menu items that are dynamically generated. These and other aspects of the invention will become apparent after reading the following detailed description.

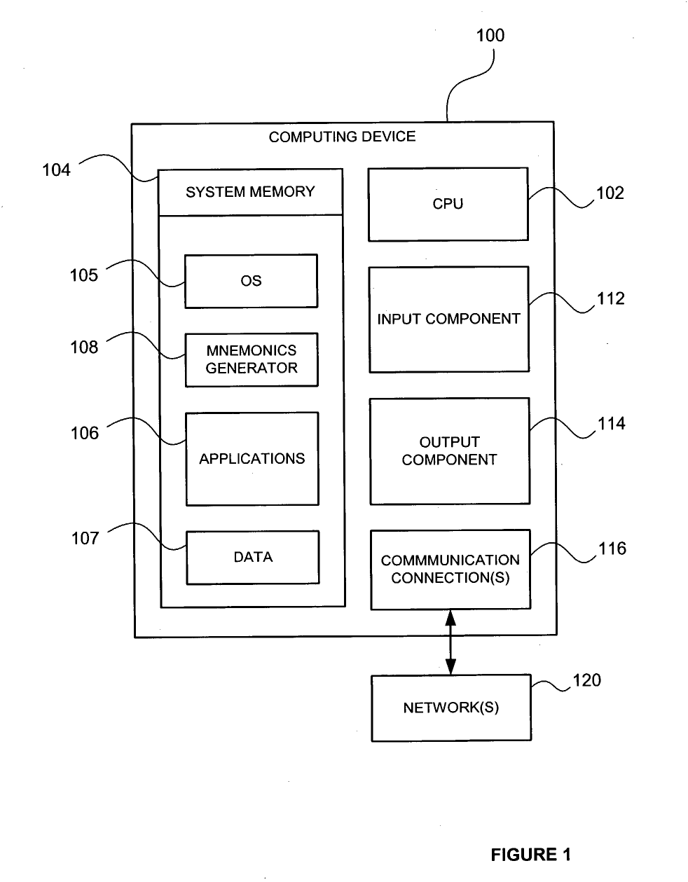

FIG. 1 illustrates an exemplary computing device that may be used in one exemplary embodiment of the present invention. With reference to FIG. 1, one exemplary system for implementing the invention includes a computing device, such as computing device 100. It is to be understood that many different kinds of computing devices may implement this invention. These computing devices include desktop computers, personal digital assistants, communication devices such as wireless phones and portable communication devices, and the like. For illustrative purposes, a general computing device 100 will be described. A computing device that is capable of implementing this invention may have more, less, or different components as those shown in FIG. 1.

Computing device 100 may include various hardware components. In a very basic configuration, computing device 100 typically includes a central processing unit 102 and system memory 104. Depending on the exact configuration and type of computing device, system memory 104 may include volatile memory, non-volatile memory, data storage devices, or the like. These examples of system memory 104 are all considered computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also contain input component 112 for inputting data. In particular, input component 112 may include a keyboard, which is any key-based input device such as a full-sized keyboard, a compact keyboard, and various types of keypads. Computing device 100 may also contain output component 114 for displaying data.

Computing device 100 may also contain communication connections 116 that allow the device to communicate with other computing devices over network 120, such as a wireless network, local area network, wide area network such as the Internet, and other communication networks. Communication connections 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Software components of computing device 100 are typically stored in system memory 104. System memory 104 typically includes an operating system 105, one or more applications 106, and data 107. Operating system 105 and applications 106 may interact with a user through a user interface. The user interface may include one or more menu items and may be configured to dynamically generate menu items. The advantage of dynamically generating menu items is that the user-interface does not overwhelm users and is not cluttered with inapplicable menu choices. Because dynamically generated menu items are not hard coded into the program code, it is difficult for a developer to designate mnemonics to the menu items in the program code. And if a mnemonic is assigned to each possible menu item that can be generated in the dynamic environment, the mnemonics resulted from this approach will be too numerous and complicated for users to remember and effectively use.

As shown in the figure, system memory 104 may also include mnemonics generator 108. Mnemonics generator 108 is a software component that automatically generates mnemonics for a user-interface. In particular, mnemonics generator 108 is configured to automatically assign mnemonics to menu items of the user interface of an application. Mnemonic generator 108 may be incorporated into the operating system 105 or applications 106, or it may be a stand-alone component.

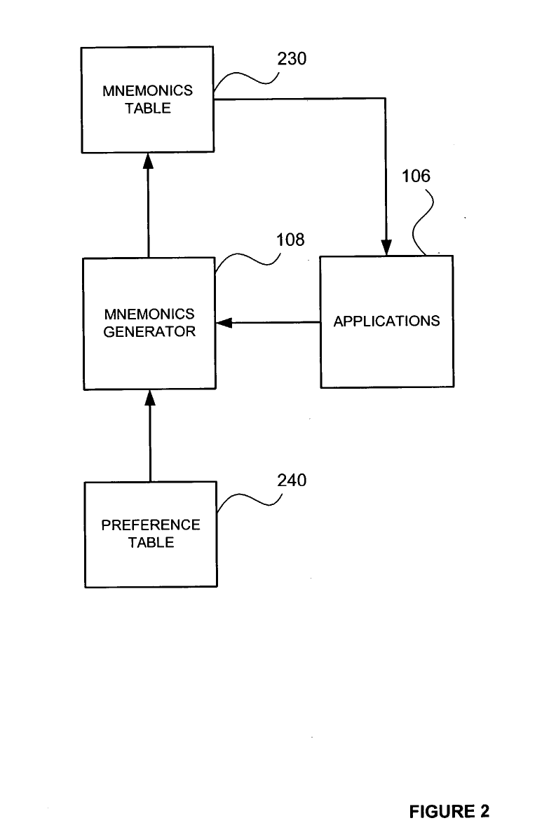

FIG. 2 is a schematic diagram of a mnemonics generating system. Illustrated is a mnemonics generator 108 that automatically assigns mnemonics to menu items. Mnemonics generator 108 is configured to determine menu items in a user interface for interacting with a user. For illustrative purposes, mnemonics generator 108 is shown to have mnemonic-related interaction with applications 106. In practice, mnemonics generator 108 may handle mnemonic generation for other computer-executable components, such as an operating system.

Applications 106 may have a preferred mnemonic for a menu item. It may indicate the preferred mnemonic by including a mnemonic indicator in the title of the menu item. For example, if one of the applications 106 has a preferred mnemonic of “o” for a menu item titled “Message Option”, the title of the menu item may be named “Message &Option” to indicate that “o” is the mnemonic.

Applications 106 may dynamically generate menu items during applications' operations. Mnemonics generator 108 is configured to automatically assign mnemonics to these dynamically generated menu items.

Preference table 240 allows applications 106 to have the same mnemonics for common menu items. For example, since many common applications have a “File” pull down menu, it would be helpful to user to assign the same mnemonic (e.g. F) to the “File” menu items for all applications. With “F” as the common mnemonic, the “File” pull down menu may be activated by pressing “alt” and “F”. Preference table 240 includes a list of menu items that are common among applications 106 and the menu items' associated mnemonics. Mnemonics generator 108 may use preference table 240 to determine a mnemonic for a menu item.

Mnemonic table 230 contains menu items used by a user interface of an application and the menu items' associated mnemonics. Mnemonics generator 108 may create and update mnemonic table 230. Mnemonic table 230 may be used by an application to convert mnemonic key input to commands for a user interface. Mnemonic features may also be offered by some other software component using mnemonic table 230.

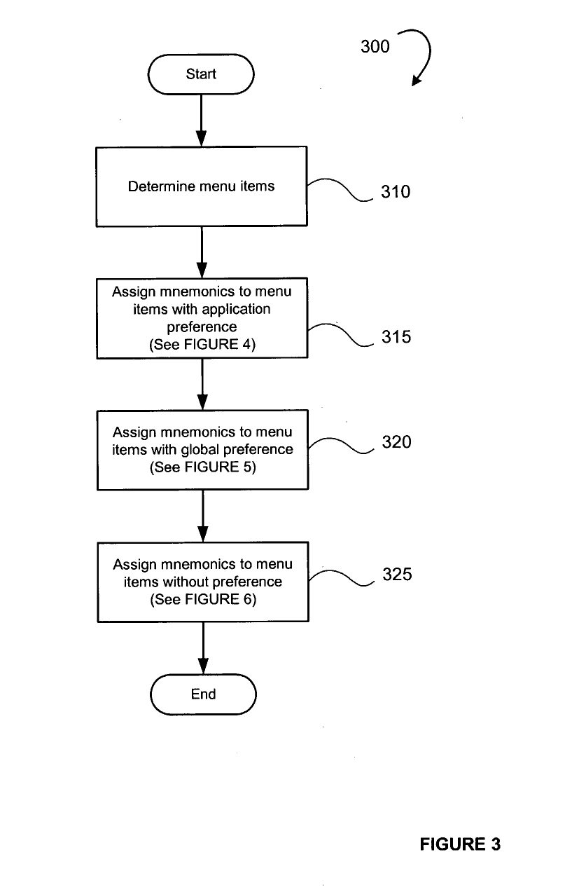

FIG. 3 is an exemplary process 300 for automatically assigning mnemonics to menu items. It is to be understood that the steps of process 300 may be performed in any order. Each step may be performed on one, a few, or, all of the menu items before the other steps are performed.

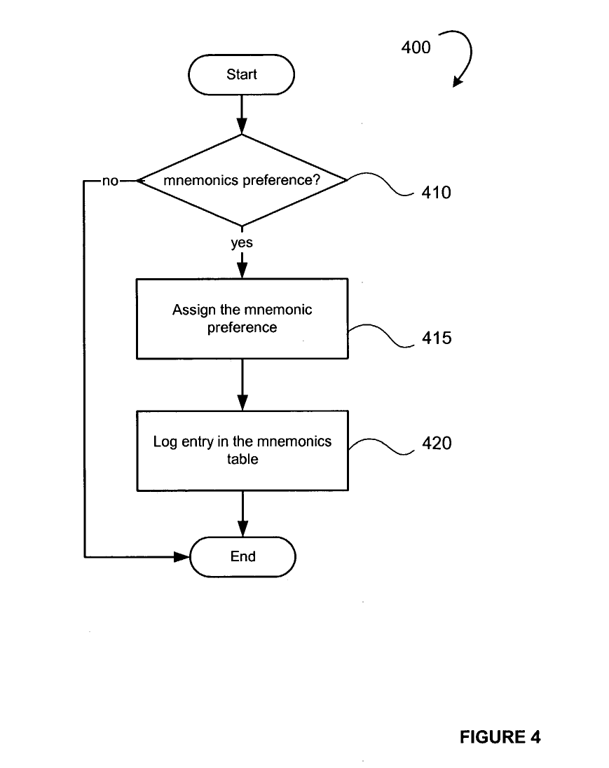

Moving from a start block, process 300 continues at block 310 where menu items are determined. At block 315, mnemonics are assigned to menu items with application mnemonic preference. Assigning menu items with application preference will be discussed in more detail in conjunction with FIG. 4. Briefly stated, the mnemonic preferred by an application may be determined from the title of the menu item.

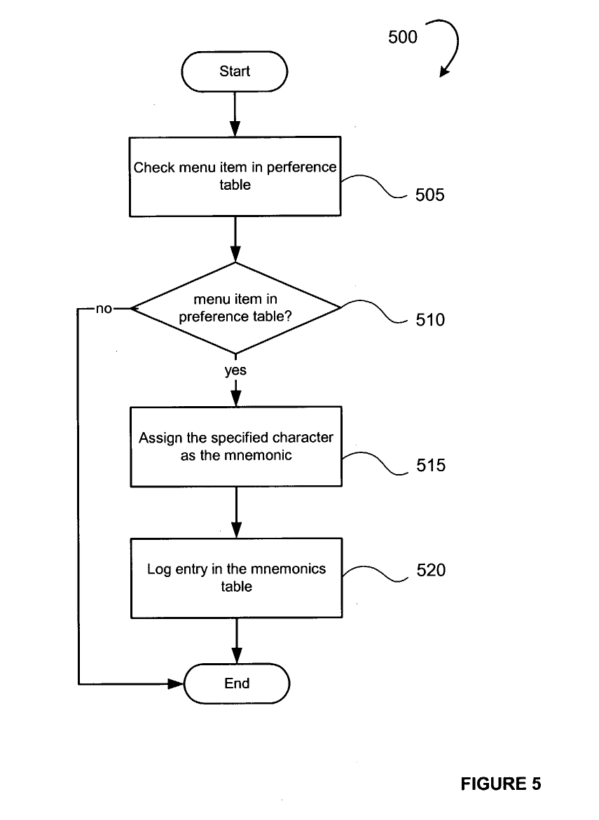

At block 320, mnemonics are assigned to menu items with global mnemonic preference. For example, these menu items may be common among applications. Thus, the mnemonics of these common menu items should be the same across applications. Assigning menu items with global preference will be discussed in more detail in conjunction with FIG. 5. Briefly stated, the global mnemonic is determined from a preference table.

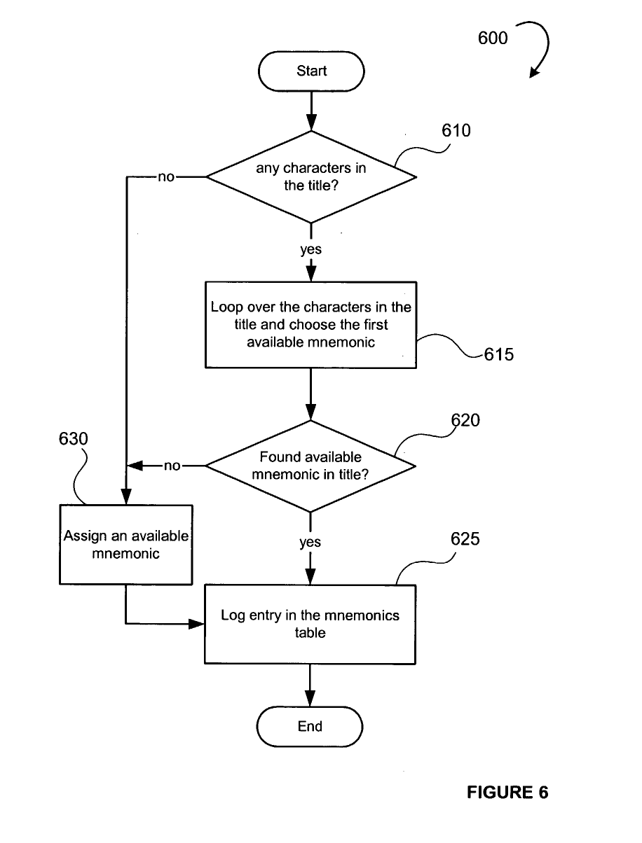

At block 325, menu items without preference are assigned. This will be discussed in more detail in conjunction with FIG. 6. Process 300 then ends.

FIG. 4 an exemplary process 400 for automatically assigning mnemonics to a menu item with an application mnemonic preference. Moving from a start block, process 400 goes to decision block 410 where a determination is made whether the menu item for an application is associated with a mnemonic preference. A menu item in an application may associate with an application mnemonic preference in any manner. For example, a developer may include a mnemonic indicator in the title of the menu item. The mnemonic indicator may be a special character, such as “$”, placed in front of a character in the title that is the preferred mnemonic. If the menu item is not associated with an application mnemonic preference, process 400 ends.

Returning to block 410, if the menu item is associated with an application mnemonic preference, the process moves to block 415 where the application mnemonic preference is assigned to the menu item. For example, if the application mnemonic preference is indicated by a mnemonic indicator, the character in the title of the menu item following the mnemonic indicator is assigned as the mnemonic. The application mnemonic preference is assigned to the menu item if the preference has not already been assigned to another menu item.

At block 420, the assigned mnemonic is logged in the mnemonic table. Then, process 400 ends.

FIG. 5 an exemplary process 500 for automatically assigning mnemonics to a menu item with a global mnemonic preference. Moving from a start block, process 500 moves to block 505 where the menu item is checked against entries in the preference table. The process continues at decision block 510 where a determination is made whether there is an entry of the menu item is in the preference table. If not, the process ends. If so, process 500 moves to block 515 where the character specified in the preference table entry is used as the mnemonic, providing that the application mnemonic preference has not already been assigned to another menu item. At block 420, the assigned mnemonic is logged in the mnemonic table. Then, the process ends.

FIG. 6 an exemplary process 600 for automatically assigning mnemonics to a menu item without a mnemonic preference. Moving from a start block, the process continues at decision block 610 where a determination is made whether the title of the menu item has a character. If not, process 600 continues at block 630 where a free character that has not been used is assigned to the menu item. The process continues at block 625 where an entry of the assigned menu item is logged into an entry in the mnemonics table. The process then ends.

Returning to decision block 610, if the title of the menu item has a character, process 600 goes to block 615 where the characters in the title are looped over and the first available mnemonic is selected. At decision block 620, a determination is made whether a mnemonic is found in the title. If so, process 600 continues at block 630 where an available character that has not been used is assigned to the menu item. In another embodiment, a character may be systematically chosen to be the mnemonic even if this character was already assigned as a mnemonic for another menu item. The process continues at block 625 where an entry of the assigned menu item is logged into an entry in the mnemonics table. The process then ends.

Returning to decision block 620, if the characters in the title were not run out, process continues at block 625 where an entry of the assigned menu item is logged into an entry in the mnemonics table. Process then ends.

The above specification, examples and data provide a complete description of the invention. Since many embodiments of the invention can be made without departing from the spirit and scope of the invention, the invention resides in the claims hereinafter appended.

What is claimed is:

1. A computer-implemented method for configuring a user-interface that includes a plurality of menu items, the computer-implemented method comprising:
automatically assigning a mnemonic to at least one of the menu items, the mnemonic being associated with a keyboard input; and
in response to the keyboard input, activating the menu item.

2. The computer-implemented method of claim 1, wherein the menu item is dynamically generated and wherein the mnemonic is automatically assigned to the menu item after the menu item has been generated.

3. The computer-implemented method of claim 1, wherein automatically assigning the mnemonic includes logging an entry associated with the mnemonic in a mnemonic table, the mnemonic table being used to associate the keyboard input to the menu item.

4. The computer-implemented method of claim 1, wherein automatically assigning the mnemonic includes:
determining whether the menu item is associated with an application mnemonic preference, the application mnemonic preference being a mnemonic preferred by the application; and
if so, assigning the application mnemonic preference to the menu item.

5. The computer-implemented method of claim 4, wherein determining whether the menu item is associated with an application mnemonic preference includes determining a mnemonic indicator in the title of the menu item.

6. The computer-implemented method of claim 5, wherein the mnemonic indicator includes a special character.

7. The computer-implemented method of claim 1, wherein automatically assigning the mnemonic includes:
determining whether the menu item is associated with a global mnemonic preference, the global mnemonic preference being a mnemonic for a menu item that is common among a plurality of applications; and
if so, assigning the global mnemonic preference to the menu item.

8. The computer-implemented method of claim 7, wherein determining whether the menu item is associated with a global mnemonic preference includes determining an entry associated with the menu item in a preference table, the preference table containing a plurality of entries associated with global mnemonic preferences.

9. The computer-implemented method of claim 1, wherein automatically assigning the mnemonic includes:
selecting a character in the title of the menu item;
determining whether the character has been used as a mnemonic for another menu item; and
if not, assigning the character as the mnemonic for the menu item.

10. The computer-implemented method of claim 9, wherein repeating the steps in claim 9 for each character in the title of the menu item until a mnemonic is assigned to the menu item.

11. The computer-implemented method of claim 1, wherein automatically assigning the mnemonic includes assigning an available character as the mnemonic for the menu item where the available character is a character that has not been assigned as a mnemonic for another menu item.

12. A computer-executable medium encoded with computer-executable components comprising:
an application configured with a user-interface that includes at least one menu item; and
a mnemonic generator configured to assign a mnemonic to the menu item, the mnemonic being associated with a keyboard input, the mnemonic generator being further configured to activating the menu item in response to the keyboard input.

13. The computer-executable medium of claim 12, wherein the application is further configured to dynamically generate the menu item for the user-interface and wherein the mnemonic generator is further configured to assign the mnemonic to the menu item after the menu item has been generated.

14. The computer-executable medium of claim 12, wherein the mnemonic generator is further configured to create an entry corresponding to the menu item in a mnemonic table and wherein the entry associates the mnemonic with the menu item.

15. The computer-executable medium of claim 14, wherein the application is further configured to determine the keyboard input associated with the mnemonic, to determine the entry associated with the mnemonic in the mnemonic table, and to activate the menu item associated with the entry.

16. The computer-executable medium of claim 12, wherein the keyboard input includes a key input associated with a character.

17. The computer-executable medium of claim 12, wherein the keyboard input includes a key input associated with a modifier key.

18. The computer-executable medium of claim 12, wherein the mnemonic generator is a sub-component of the application.

19. The computer-executable medium of claim 12, wherein the mnemonic generator is further configured to determine an application mnemonic preference associated with the menu item and to assign the application mnemonic preference as the mnemonic for the menu item.

20. The computer-executable medium of claim 12, wherein the mnemonic generator is further configured to determine a global mnemonic preference associated with the menu item and to assign the global mnemonic preference as the mnemonic for the menu item.

21. The computer-executable medium of claim 20, wherein the mnemonic generator is further configured to determine the global mnemonic preference by referring to a preference table.

22. A computer-readable medium encoded with computer executable instructions for configuring an application with a user-interface comprising:
means for automatically assigning a mnemonic to a menu item associated with the user interface, the mnemonic being associated with a keyboard input; and
means for activating the menu item in response to the keyboard input.

23. The computer-readable medium of claim 22, further comprising means for assigning an application mnemonic preference to the menu item.

24. The computer-readable medium of claim 22, further comprising means for assigning a global mnemonic preference to the menu item.

25. The computer-readable medium of claim 22, further comprising means for determining the keyboard input.

26. The computer-readable medium of claim 22, further comprising means for dynamically generating the menu item and means for automatically assigning the mnemonic to the dynamically generated menu item.

27. The computer-readable medium of claim 22, further comprising means for automatically assigning the mnemonic based on the title of the menu item.
